(19) United States
(12) Patent Application Publication
(10) Pub. No.: US 2007/0231502 A1
(43) Pub. Date: Oct. 4, 2007

(54) Method for incorporating additives into polymers

(76) Inventors: Kyle Richard Jones, Middletown, DE (US); Nancy Cliff, Ringwood, NJ (US); David Yale, Bethel, CT (US); Mouhcine Kanouni, New York, NY (US); Simon Lord, St. Kilda (AU)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/715,778

(22) Filed: Mar. 8, 2007

Related U.S. Application Data
(60) Provisional application No. 60/785,442, filed on Mar. 24, 2006.

(51) Int. Cl. B29C 71/04

(52) U.S. Cl. 427/532

(57) ABSTRACT

This invention is a method for incorporating additives into a polymeric materials such as coatings and plastics, which comprises treating the polymeric material with light prior to applying a removable coating of a composition comprising the additives to the surface of the polymeric material and allowing the coating to remain in contact with the polymeric material for a time sufficient to allow the additives to diffuse into the polymeric material.

This application claims benefit under 35 USC 119(e) of U.S. provisional application No. 60/785,442, filed Mar. 24, 2006, incorporated herein in its entirety by reference.

This invention provides a method to incorporate additives into polymeric substrates by treating the surface of the substrate with light prior to the application of a removable coating containing the additives and allowing the additives to diffuse into the substrate.

### BACKGROUND OF THE INVENTION

Co pending U.S. patent application Ser. No. 11/235,571, filed Sep. 26, 2005, incorporated herein in its entirety by reference, discloses a method for replenishing or introducing light stabilizers into a polymeric substrate which requires no active heating of the polymer. In said method, a removable coating composition comprising an effective amount of an ultraviolet light absorber (UVA), a hindered amine light stabilizer (HALS) or both is applied to the substrate surface. The removable coating is formulated with a non-reactive carrier with sufficient viscosity or film forming properties to maintain a coherent layer on the polymeric substrate for a time sufficient to allow the UVA, HALS or both to diffuse into the substrate. The coating layer remains in contact with the polymeric substrate for a time sufficient to allow the stabilizers to diffuse into the substrate after which time the coating may optionally be removed.

Using the method of U.S. patent application Ser. No. 11/235,571 light stabilizers are incorporated into polymeric materials such as automotive coatings, marine coatings, protective and functional films, thermoplastic articles and thermoplastic composite articles like plastic lumber. The method is used to replenish light stabilizers (LS) into an aged or weathered material, introduce LS to non-light stabilized material, or fortify the LS of an already stabilized system.

It has been found that exposing the polymeric substrate which is to be treated by this method to light, for example Ultra Violet light, prior to application of the removable coating layer, greatly enhances the amount of stabilizer which is incorporated into the substrate.

U.S. Pat. No. 5,487,914 discloses a method for replenishing UVAs in automotive coatings and U.S. Pat. Nos. 4,322,455 and 4,323,597 disclose a method for impregnating the surface of polycarbonate with UVAs. Each method requires an added heating step.

U.S. Pat. No. 4,146,658 also discloses a method for surface impregnation of polycarbonate. All of the examples comprise heating the polycarbonate to 250° F. U.S. Pat. Nos. 4,146,658; 4,322,455 and 4,323,597 all require a selection of very specific solvents to both facilitate UVA penetration and prevent marring of the polymer surface.

Typically, additives, such as light stabilizers, are incorporated into the polymer system at some processing step prior to, or including, the formation of a polymeric article, application of a film, or curing of a coating.

The present invention allows one to efficiently incorporate additives into the surface of a polymer system after a polymer is processed, e.g., after an article is formed, a film is applied or a coating is cured.

For example, the invention allows one to incorporate temperature sensitive materials into a substrate after thermal processing; incorporate stabilizers, such as light stabilizers (LS), into the surface of a substrate where they are most needed to protect the substrate; and to incorporate additives, including LS and other stabilizers, into a photocured system without interfering with photocuring.

### DESCRIPTION OF THE INVENTION

The present invention provides a method for incorporating light stabilizers into a polymeric substrate, which method comprises:

preparing a removable coating composition comprising an effective amount of an additive or additives formulated with a non-reactive carrier with sufficient viscosity or film forming properties to maintain a coherent layer on the polymeric substrate for a time sufficient to allow the additive or additives to diffuse into the substrate;

treating the surface of the polymeric substrate with light for a time sufficient to enhance diffusion into the substrate of the additive or additives of the removable coating composition;

after treatment with light applying the removable coating composition containing the additive or additives to the polymeric substrate; and

allowing the coating composition to remain in contact with the polymeric substrate for a sufficient time to allow the additive or additives to diffuse into the substrate.

Residue of the coating may be removed by methods such as washing etc. after sufficient additive diffusion has occurred. Alternately, the coating residue may be left on the substrate indefinitely or until natural erosion or wear causes removal of the residue.

The composition may be in liquid, emulsified liquid, gel or low melting solid form and may also include a substantially non-volatile solvent capable of swelling the substrate.

By controlling viscosity or film forming properties of the coating composition, no active heating of the polymeric substrate is required after application of the removable coating. Ambient conditions will generally suffice to allow diffusion of stabilizers. However, gentle heating of the substrate, for example, up to about 60° C., for example up to about 40° C. or up to about 30° C., after the coating is applied will hasten additive migration and is included as one embodiment of the invention.

In one embodiment of the instant invention, the additive or additives of the removable coating composition are stabilizers such as primary and secondary antioxidants, light stabilizers such as Ultra Violet absorbers and hindered amine light stabilizers, hydroxylamines, nitrones, other radical traps etc.

For example, the stabilizers are selected from the group of Ultra Violet absorbers and hindered amine light stabilizers (HALS).

For example, a removable coating of the instant invention which is a light stabilizing composition, comprises, at a minimum, a non-reactive carrier and at least one light stabilizing compound selected from the group consisting of UV absorbers and HALS. A non-reactive carrier is a carrier that is substantially non-reactive toward the UV absorber, the HALS or the polymer. This carrier may be a liquid or low melting solid (i.e., having a melting point below about 50° C.), but is preferably a liquid because it optimally insures intimate contact between the carrier and the polymeric material substrate during the invention method. The carrier may be a single component or comprise a mixture of components which may be volatile or non-volatile. The particular carrier is not critical to the invention method as long as it wets the polymeric material surface during the invention method.

The removable coating composition is also formulated to have a viscosity high enough to remain in contact with the polymeric material for a period of time sufficient to allow for the diffusion of the additives into the polymer. The carrier may therefore also comprise thickeners and other rheology modifiers.

Prior to the application of the removable coating composition of the instant invention, the polymeric substrate to be treated is exposed to light, typically Ultra Violet light or high intensity white light. This exposure facilitates diffusion of the additives into the polymeric substrate. In certain cases, even ambient indoor or outdoor light may suffice.

The light used in treating the polymeric substrate can therefore extend from about 190 nm to 800 nm (UV-vis region). In general, wavelengths between about 190 nm to 600 nm will prove useful and wavelengths of light in the UV region, approximately 190 nm to 400 nm are expected to be most generally effective. Both UV light and visible light may be used at the same time, for example, the substrate may be treated with light of any number of wavelengths ranging between approximately 190 nm to 800 nm.

In a particular embodiment, the light comprises UV light.

As suitable radiation is present, for example, in sunlight or light from artificial light sources, a large number of very different types of light sources are employed. Both point sources and arrays (“lamp carpets”) are suitable. Examples are carbon arc lamps, xenon arc lamps, medium-, high-, super high- and low-pressure mercury lamps, possibly with metal halide dopes (metal-halogen lamps), microwave-stimulated metal vapor lamps, excimer lamps, superactinic fluorescent tubes, fluorescent lamps, argon incandescent lamps, electronic flashlights, photographic flood lamps, and light emitting diodes (LED). The distance between the lamp and the substrate to be exposed in accordance with the invention may vary depending on the polymeric substrate and the type and out-put of lamp, and may be, for example, from a centimeter or two to several meters, for example from about 2 cm to 5 m.

The wavelengths of light used, the intensity of the light and the time the polymeric substrate is exposed will all depend on the polymer of the substrate. For example, polyolefins typically absorb very little light while PET absorbs UV light strongly. The presence in the polymer of additives that absorb light, such as dyes, will also affect the amount of exposure required. The propensity of the polymer to undergo light induced reactions is also an important factor.

The amount of exposure to light that the polymer is subjected to is enough to allow for enough reactions at the surface to permit ready diffusion of the additives, but not enough to cause noticeable light degradation of the polymer. For example, the amount of light typically encountered in UV curing of a coating will suffice in some cases. Fusion H, D and V bulbs are typical light sources in UV curing apparatus and combinations of these bulbs in a single exposure are common.

Other convenient sources of light include xenon and pulsed xenon light as used in accelerated weathering, mercury lamps and sun lamps.

As a shorter exposure time is generally preferred, mercury emission lamps and pulsed xenon are attractive sources of light for carrying out the instant method.

While the light source and the substrate being treated will both be factors in determining the amount of light needed to carry out the invention, it is anticipated that a dose of light of at least about 1 joule/cm² will be required. Typical doses of light will range from about 3 to about 250 joule/cm², for example from about 5 to about 150 joule/cm², or for example from about 5 to about 50 joule/cm².

Obviously, a certain amount of experimentation to arrive at the best light exposure conditions for an individual application will be necessary, but this is well within the ability of the practitioner.

For example, a polymeric substrate such as a shaped article, thermoplastic film or cured coating film may be exposed in an UV curing apparatus, such as a Fusion 600 watt VPS unit using H, D and/or V bulbs prior to treatment with the removable coating containing the additives. The substrate passes through the UV curing apparatus and the exact dose of light is determined by the power setting of the apparatus, the type of bulb(s) used and the speed at which the substrate is conveyed through the apparatus. More than one pass through the apparatus may be employed.

For example, a polymeric substrate such as a shaped article, thermoplastic film or cured coating film may be exposed to the light source found in an Atlas Ci65 Xenon Weatherometer for about 1 to 200 hours prior to treatment with the removable coating containing the additives. Using borosilicate inner and/or outer filters will decrease the amount of light available and lengthen the amount of time required, but the presence of the filters will block light with wavelengths below about 290 nm which light may cause unwanted degradation of the polymer. Also, as the distance between the light source and the substrate gets larger, the amount of time needed for exposure will also increase.

A substrate comprising, for example, a melamine crosslinked acrylic coating or a polypropylene plaque or a polyester sheet may be exposed to an unfiltered UV light source, such as a mercury emission lamp or pulsed xenon lamps, for 0.5 to 24 hours prior to treatment with the removable coating containing the additives. The use of filters blocking out light below 250 or 290 nm may increase the required exposure time.

The presence of moisture during light treatment need not necessarily be excluded, and in certain cases may aid the process. There are no limits placed on the temperatures during light treatment except that they are not high enough to cause harm or deformation of the substrate.

After application of the removable coating, the polymeric substrate can be held at ambient temperature or heated gently, for example, heated between about 30° C. and about 70° C. For Example the polymeric substrate can be held overnight at ambient temperatures or heated in an oven or a warmed room at temperatures between about 40° C. and about 60° C. for about 0.5 to about 8 hours. Again, some experimentation will be required to ascertain the best conditions, longer times than these may be needed, and economics will no doubt drive the practitioner in choosing the ultimate conditions.

Once it has been determined that the additives have sufficiently migrated into the polymeric substrate the coating may be washed off. In the case of UV absorbing additives, this is conveniently done by measuring the UV absorbance of the polymer, perhaps in the form of an analytical standard treated along with the substrate of interest, at various times after application of the removable coating. Of course once a method is standardized, this determination becomes a matter of quality control used at the discretion of the practitioner.

It may not be necessary to remove the coating, and in some cases it may be beneficial to not remove it, such as when the polymeric substrate will be stored for a period of time or when the removable coating composition is also a polish, protective wax or a formulation with some other useful function.

The present invention can be used to incorporate additives into any polymer, co-polymer or polymer blend. Polymeric materials, or polymeric substrates, include natural polymers, e.g., wood and natural fibers, and synthetic polymers including thermoplastic, thermoset, elastomeric, inherently crosslinked or crosslinked polymers.

Natural polymers include cotton, viscose, flax, rayon, linen, wool, cellulose, natural rubber, or polymer-homologously chemically modified derivatives thereof, such as cellulose acetates, propionates and butyrates, the cellulose ethers such as methyl cellulose and also colophonium resins and derivatives.

Many paints and coatings benefit from the present method and include, but are not limited to, those used as basecoats and clear coats in automotive applications. Exemplary of such automotive coatings are acrylic/melamine, acrylic/urethane, polyester/urethane, and epoxy/acid type paints and include coatings based on or incorporating silane functionality.

It is also readily apparent that other coating systems including marine coatings, wood coatings, other coatings for metals and coatings over plastics and ceramics would benefit from the present disclosure. Exemplary of such marine coatings are gel coats comprising an unsaturated polyester, a styrene and a catalyst. Powder coatings and UV cured coatings are also of interest.

Plastics and plastic articles would benefit from the present method and include, but are not limited to, plastics used in the manufacture of automotive or machine parts, glazing, outdoor furniture, boats, vinyl siding, protective films, composites like plastic lumber and fiber reinforced composites, and films used in displays. Exemplary of such plastics are polypropylene, polyethylene, PVC, styrenics, polyamides, urethanes, aliphatic polyesters, aromatic polyesters, poylcarbonates, thermoplastic polyolefins, ionomers, unsaturated polyesters and blends of polymer resins including ABS, SAN and PC/ABS. For Example, the plastic is a polyolefin, thermoplastic polyolefin, PVC, ABS, or PC/ABS.

Other specific examples of thermoplastic, thermoset, elastomeric, inherently crosslinked or crosslinked polymers are found in co pending U.S. patent application Ser. No. 11/235,571, already incorporated herein in its entirety by reference.

The polymers may be, for example, in the form of films, coatings, injection-moulded articles, extruded workpieces, fibres, sheets, felts or woven fabrics.

The final form of the polymeric substrate is not relevant. For example molded articles such as automotive fascia and mailboxes as well as articles constructed from synthetic fibers such as awnings, carpets and furniture parts, and rubber articles such as outdoor matting can all benefit from the instant method.

The polymers may be, for example, polymers found in coatings such as in auto coatings, paints, stains, laminates, or other protective or decorative coatings.

The polymeric substrate may optionally also contain various conventional additives such as antioxidants, UV absorbers, hindered amines, phosphites or phosphonites, benzo-furan-2-ones, thiosynergists, polyamide stabilizers, metal stearates, nucleating agents, fillers, reinforcing agents, lubricants, emulsifiers, dyes, pigments, dispersants, optical brighteners, flame retardants, antistatic agents, blowing agents and the like.

The instant method is quite effective for introducing light stabilizers, Ultra Violet absorbers (UVAs) and hindered amine light stabilizers (HALS).

The UVAs may be any such additive, or mixture of UVAs, many of which are well known in the art. Exemplary of such materials are 2-(2-hydroxyphenyl)-2H-benzotriazoles, tris-aryl-o-hydroxyphenyl-s-triazines, ortho-hydroxybenzophenones, cyanoacrylates, oxanilides, benzylidene malonates, benzoxazinone UV absorbers, esters of substituted and unsubstituted benzoic acids including cinnamates and salicylates, formamidines, dibenzoylmethanes and esters of para-aminobenzoic acid. The exact UVA or mixture of UVAs chosen will depend largely on the particular application. For example, for more demanding applications, the more robust UVAs, e.g., benzotriazoles, ortho-hydroxybenzophenones and triphenyltriazines will be preferred.

2-(2-Hydroxyphenyl)-2H-benzotriazoles are, for example, known commercial hydroxyphenyl-2H-benzotriazoles and benzotriazoles as disclosed in U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905, 4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzo-triazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butyl-phenyl)-2H-benzotriazole, 5-trifluoromethyl-2-(2-hydroxy-3,5-di-t-butylphenyl)-2H-benzo-triazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

Tris-aryl-o-hydroxyphenyl-s-triazines are, for example, known commercial tris-aryl-o-hydroxyphenyl-s-triazines and triazines as disclosed in U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,736,597; 5,942,626; 5,959,008; 5,998,116; 6,013,704; 6,060,543; 6,242,598 and 6,255,483, for example 4,6-bis-(2,4-dimethylphenyl)-2-(2-hydroxy-4-octyloxyphenyl)-s-triazine, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxy-ethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxy-ethoxy)phenyl]-6-(4-bromophenyl)-s-triazine, 2,4-bis[2-hydroxy-4-(2-acetoxyethoxy)-phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbonyl-ethylideneoxyphenyl)-s-triazine, 2-phenyl-4-[2-hydroxy-4-(3-sec-butyloxy-2-hydroxy-propyloxy)phenyl]-6-[2-hydroxy-4-(3-sec-amyloxy-2-hydroxypropyloxy)phenyl]-s-triazine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2-hydroxy-4-(3-nonyloxy*-2-hydroxypropyloxy)-5-α-cumyl-phenyl]-s-triazine (* denotes a mixture of octyloxy, nonyloxy and decyloxy groups), methylenebis-{2,4-bis(2,4-dimethylphenyl)-6-[2-hydroxy-4-(3-butyloxy-2-hydroxy-propoxy)phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylidene-oxyphenyl)-s-triazine, 2,4-bis(2,4-dimethylphenyl)-6-(2-hydroxy-4-hexyloxy-5-α-cumyl-phenyl)-s-triazine, 2-(2,4,6-trimethylphenyl)-4,6-bis[2-hydroxy-4-(3-butyloxy-2-hydroxy-propyloxy)phenyl]-s-triazine, 2,4,6-tris[2-hydroxy-4-(3-sec-butyloxy-2-hydroxypropyloxy)-phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

2-Hydroxybenzophenones are, for example, the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

Esters of substituted and unsubstituted benzoic acids are, for example, 4-tert-butylphenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate. Octyl methoxycinnamate; 2-Ethylhexyl-p-methoxycinnamate; 2-Ethylhexyl methoxycinnamate; 2-Ethylhexyl-4-methoxycinnamate; 2-Propenoic acid, 3-(4-methoxyphenyl)-, 2-ethylhexyl ester; Octinoxate; and 2-Ethylhexyl p-methoxycinnamate.

Cyanoacrylates and benzylidene malonates are, for example, α-cyano-β,β-diphenylacrylic acid ethyl ester or isooctyl ester, α-carbomethoxy-cinnamic acid methyl ester, α-cyano-β-methyl-p-methoxy-cinnamic acid methyl ester or butyl ester, α-carbomethoxy-p-methoxy-cinnamic acid methyl ester, N-(β-carbomethoxy-β-cyanovinyl)-2-methyl-indoline, dimethyl p-methoxybenzylidenemalonate, and di-(1,2,2,6,6-pentamethylpiperidin-4-yl)p-methoxybenzylidenemalonate.

Oxanilides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

For example, the UVA is one or more compounds selected from the group consisting of
2-(3′,5′-di-tert-amyl-2′-hydroxyphenyl)benzotriazole,
2-(3′-tert-butyl-2′-hydroxy-5′-(2-octyloxycarbonylethyl)phenyl)benzotriazole,
the transesterification product of 2-[3′-tert-butyl-5′-(2-methoxycarbonylethyl)-2′-hydroxyphenyl]-2H-benzotriazole with polyethylene glycol 300,
2-[2′-hydroxy-3′-(α,α-dimethylbenzyl)-5′-(1,1,3,3-tetramethylbutyl)phenyl]benzotriazole,
5-trifluoromethyl-2-(2-hydroxy-3-α-cumyl-5-tert-octylphenyl)-2H-benzotriazole,
2-(2′-hydroxy-5′-(2-hydroxyethyl)phenyl)benzotriazole,
2,4-bis(2-hydroxy-4-butyloxyphenyl)-6-(2,4-bis-butyloxyphenyl)-1,3,5-triazine,
the reaction product of tris(2,4-dihydroxyphenyl)-1,3,5-triazine with the mixture of α-chloropropionic esters (made from isomer mixture of C₇-C₉alcohols),
2-[4-(dodecyloxy/tridecyloxy-2-hydroxypropoxy)-2-hydroxyphenyl]-4,6-bis(2,4-dimethylphenyl)1,3,5-triazine,
2-(5′-tert.octyl-2′-hydroxyphenyl)-benzotriazole,
2-(3′-dodecyl-5′-methyl-2′-hydroxyphenyl)-benzotriazole,
2-(3′-tert.butyl-5′-(2-octyloxycarbonylethyl)-2′-hydroxyphenyl)-5-chloro-benzotriazole,
2-ethylhexyl-p-methoxycinnamate,
2,4-dihydroxybenzophenone,
2-hydroxy-4-methoxybenzophenone,
2-hydroxy-4-dodecyloxybenzophenone,
2-hydroxy-4-octyloxybenzophenone,
2,2′-dihydroxy-4-methoxybenzophenone,
α-cyano-β,β-diphenylacrylic acid ethyl ester or isooctyl ester,
α-carbomethoxy-cinnamic acid methyl ester,
α-cyano-β-methyl-p-methoxy-cinnamic acid methyl ester or butyl ester,
α-carbomethoxy-p-methoxy-cinnamic acid methyl ester,
dimethyl p-methoxybenzylidenemalonate,
di-(1,2,2,6,6-pentamethylpiperidin-4-yl)p-methoxybenzylidenemalonate
2,2′-diethoxyoxanilide,
2,2′-dioctyloxy-5,5′-di-tert-butoxanilide,
2,2′-didodecyloxy-5,5′-di-tert-butoxanilide,
2-ethoxy-2′-ethyloxanilide,
N,N′-bis(3-dimethylaminopropyl)oxamide,
2-ethoxy-5-tert-butyl-2′-ethoxanilide and its mixture with 2-ethoxy-2′-ethyl-5,4′-di-tert-butoxanilide, and
mixtures of o- and p-methoxy-disubstituted oxanilides and mixtures of o- and p-ethoxy-disubstituted oxanilides.

For example, the UVA is one or more compounds selected from the group consisting of
2-(3′-tert-butyl-2′-hydroxy-5′-(2-octyloxycarbonylethyl)phenyl)benzotriazole,
the transesterification product of 2-[3′-tert-butyl-5′-(2-methoxycarbonylethyl)-2′-hydroxyphenyl]-2H-benzotriazole with polyethylene glycol 300,
2-[2′-hydroxy-3′-(α,α-dimethylbenzyl)-5′-(1,1,3,3-tetramethylbutyl)phenyl]benzotriazole,
5-trifluoromethyl-2-(2-hydroxy-3-α-cumyl-5-tert-octylphenyl)-2H-benzotriazole,
the reaction product of tris(2,4-dihydroxyphenyl)-1,3,5-triazine with the mixture of α-chloropropionic esters (made from isomer mixture of C₇-C₉alcohols),
2-[4-(dodecyloxy/tridecyloxy-2-hydroxypropoxy)-2-hydroxyphenyl]-4,6-bis(2,4-dimethylphenyl)1,3,5-triazine,
2-(3′-dodecyl-5′-methyl-2′-hydroxyphenyl)-benzotriazole,
2-(2′-hydroxy-5′-(2-hydroxyethyl)phenyl)benzotriazole,
2,2′-dihydroxy-4-methoxybenzophenone,
2,2′,4,4′-tetrahydroxybenzophenone,
α-cyano-β,β-diphenylacrylic acid ethyl ester or isooctyl ester,
di-(1,2,2,6,6-pentamethylpiperidin-4-yl)p-methoxybenzylidenemalonate, and
2-ethoxy-2′-ethyloxanilide,

The HALS included in the composition may be any such additives, or mixture of HALS, many of which are well known in the art. The HALS may also be oligomeric or polymeric.

HALS are, for example, 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis-(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl) succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

The sterically hindered amine may also be one of the compounds described in U.S. Pat. Nos. 5,980,783; 6,046,304 and 6,297,299, the disclosures of which are hereby incorporated by reference.

HALS are also sterically hindered amines substituted on the N-atom by a hydroxy-substituted alkoxy group, for example, compounds such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, bis(1-(2-hydroxy-2-methylpropoxy)-2,2,6,6-tetramethylpiperidin-4-yl)glutarate and 2,4-bis{N-[1-(2-hydroxy-2-methylpropoxy)-2,2,6,6-tetramethylpiperidin-4-yl]-N-butylamino}-6-(2-hydroxyethyl-amino)-s-triazine.

For example, the HALS is one or more compounds selected from the group consisting of
bis(1,2,2,6,6-pentamethylpiperidin-4-yl)sebacate,
bis(1-octyloxy-2,2,6,6-tetramethylpiperidin-4-yl) sebacate,
bis(2,2,6,6-tetramethylpiperidin-4-yl) sebacate,
7-Oxa-3,20-diazadispiro[5.1.11.2]heneicosane-20-propanoic acid, 2,2,4,4-tetramethyl-21-oxo-, dodecyl ester,
3-dodecyl-1-(2,2,6,6-tetramethyl-4-piperidinyl)-2,5-Pyrrolidinedione,
1-acetyl-4-(3-dodecyl-2,5-dioxo-1-pyrrolidinyl)-2,2,6,6-tetramethyl-piperidine,
2,4-bis[N-Butyl-N-(1-cyclohexyloxy-2,2,6,6 tetramethylpiperidin-4-yl) amino]-6-(2-hydroxyethylamine)-1,3,5-triazine,
4-hydroxy-2,2,6,6-tetramethylpiperidine,
4-hydroxy-1,2,2,6,6-pentamethylpiperidine,
2-undecyl-7,7,9,9-tetramethyl-1-oxa-3,8-diaza-4-oxo-spiro[4,5]decane,
bis(2,2,6,6-tetramethylpiperidin-4-yl)sebacate,
polycondensation product of 2,4-dichloro-6-tert-octylamino-s-triazine and 4,4′-hexa methylenebis(amino-2,2,6,6-tetramethylpiperidine),
bis(1,2,2,6,6-pentamethylpiperidin-4-yl)sebacate,
4-stearyloxy-2,2,6,6-tetramethylpiperidine,
N,N′,N″,N′″-tetrakis[(4,6-bis(butyl-1,2,2,6,6-pentamethylpiperidin-4-yl)-amino-s-triazin-2-yl]-1,10-diamino-4,7-diazadecane,
N-2,2,6,6-tetramethylpiperidin-4-yl-n-dodecylsuccinimide,
N-1 ,2,2,6,6-pentamethylpiperidin-4-yl-n-dodecylsuccinimide,
4-C₁₅-C₁₇alkanoyloxy-2,2,6,6-tetramethylpiperidine,
1,5-bis(2,2,6,6-tetramethylpiperidin-4-yl)-1,5-diaza-4-oxopropane,
1,3,5-tris[3-(2,2,6,6-tetramethylpiperidin-4-ylamino)-2-hydroxy-propyl)isocyanurate,
di-(1,2,2,6,6-pentamethylpiperidin-4-yl) p-methoxybenzylidenemalonate and
the polycondensation product of 2,4-dichloro-6-[N-butyl-N-(2,2,6,6-tetramethylpiperidin-4-yl)amino]-s-triazine and 1,10-diamino-4,7-diazadecane.

For example, the HALS is one or more compounds selected from the group consisting of
bis(1,2,2,6,6-pentamethylpiperidin-4-yl)sebacate,
bis(1-octyloxy-2,2,6,6-tetramethylpiperidin-4-yl)sebacate,
bis(2,2,6,6-tetramethylpiperidin-4-yl)sebacate,
7-Oxa-3,20-diazadispiro[5.1.11.2]heneicosane-20-propanoic acid, 2,2,4,4-tetramethyl-21-oxo-, dodecyl ester,
3-dodecyl-1-(2,2,6,6-tetramethyl-4-piperidinyl)-2,5-pyrrolidinedione,
1-acetyl-4-(3-dodecyl-2,5-dioxo-1-pyrrolidinyl)-2,2,6,6-tetramethyl-piperidine, and
2,4-bis[N-Butyl-N-(1-cyclohexyloxy-2,2,6,6 tetramethylpiperidin-4-yl)amino]-6-(2-hydroxyethylamine)-1,3,5-triazine.

More than one UVA or HALS can be present in the removable coating and UVAs and HALS may be used together.

The invention can add such stabilizers to a non-stabilized system, fortify a stabilizer formulation already present in a polymer system, or replace stabilizers lost during processing or use.

Other stabilizers are also incorporated via the instant method for example:

Antioxidants including alkylated monophenols, alkylthiomethylphenols, hydroquinones and alkylated hydroquinones, tocopherols, hydroxylated thiodiphenyl ethers, alkylidenebisphenols, benzyl compounds, hydroxybenzylated malonates, aromatic hydroxybenzyl compounds, benzylphosphonates, acylaminophenols, esters of β-(3,5-di-tert-butyl-4-hydroxyphenyl)propionic acid, esters of β-(5-tert-butyl-4-hydroxy-3-methylphenyl)propionic acid, esters of β-(3,5-dicyclohexyl-4-hydroxyphenyl)propionic acid, esters of 3,5-di-tert-butyl-4-hydroxyphenyl acetic acid, amides of β-(3,5-di-tert-butyl-4-hydroxyphenyl)propionic acid, ascorbic acid, aminic antioxidants, phenothiazines phosphites and phosphonites;

Hydroxylamines, nitrones and amine oxides, for example amine oxide derivatives as disclosed in U.S. Pat. Nos. 5,844,029 and 5,880,191, dodecyl methyl amine oxide, tridecyl amine oxide, tridodecyl amine oxide and trihexadecyl amine oxide;

Benzofuranones and indolinones, for example those disclosed in U.S. Pat. Nos. 4,325,863, 4,338,244, 5,175,312, 5,216,052, 5,252,643 5,369,159 5,356,966 5,367,008 5,428,177 or 5,428,162 or 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxy-phenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, and 3-(2,3-dimethylphenyl)-5,7-di-tert-butyl-benzofuran-2-one; and

Thiosynergists, for example dilauryl thiodipropionate or distearyl thiodipropionate.

Applications where the method of the instant invention are useful include a photo-cured system where the presence of certain light stabilizers might interfere with cure, a thick article where additives such as light stabilizers are needed only at the surface rather than throughout the bulk or when processing conditions are too demanding, e.g., high heat or strong acid catalyst, for the additives to be added earlier. Incorporation of additives into the surface rather than throughout the bulk of a substrate also provides great economic savings.

Additives other than stabilizers are also incorporated via the method of the instant invention, for example dispersing agents, plasticizers, pigments, dyes, optical brighteners, flow-control agents, flame proofing agents, antistatic agents, clarifiers, preservatives and biocides.

Other applications for the invention will become apparent to the practitioner.

In order to form the removable coating composition, the additives are mixed with the non-reactive carrier and any other ancillary materials of the composition according to any technique, the particular mixture nor processing being critical to this invention. The specific additives, such as the UVAs, HALS or other additives selected will depend on the composition of the carrier. For example, the additives selected must form a solution, suspension or emulsion stable enough to allow for an even and efficient application to the polymeric substrate.

The rheology should ideally be pseudoplastic, allowing for easy application during shear-thinning processes such as spraying, yet quickly recovering viscosity upon deposition and removal of the shear.

The rate at which an additive diffuses from a specific carrier into the polymeric substrate will also impact the selection of both stabilizer and concentration employed.

The amount of additives present in the coating composition will also depend on the form of the coating and manner of application to the substrate. The coating composition may be in liquid, emulsified liquid, gel or low melting solid form. It is essential that an additive remain in contact, with the polymer surface long enough to allow diffusion of additive into the polymer. The coating formulations therefore have the following properties.

If a liquid, the coating composition during application has a viscosity, when measured by a Brookfield Viscometer using a #4 spindle at 20 rpm, of at least about 500 cps, for example between about 500 and about 10,000 cps, for example between about 500 and about 5000 cps, or for example between about 1000 and about 2500 cps.

The thickness of the coating composition on the polymeric substrate is between about 25 and about 1000 microns as applied, although choosing the optimal thickness will be dependent on several factors including additive concentration, and would be within the skill of one in the art in view of the present disclosure. For example, the coating composition is applied to a wet film thickness of between about 50 and 600 microns, for example between about 50 and 200 microns.

This layer may dry through evaporation of volatile components to leave a film much thinner than 25 to 1000 microns, provided that the amount of additives held over the polymer surface remains at least 0.2 g/m² throughout the time required for diffusion. For example, the additives contained within the coating layer, either wet film or dry film, is between about 0.2 g/m² and about 10 g/m², or between about 0.5 g/m² and 6 g/m². For example, the coating composition is formulated and applied to leave a coherent layer on the polymer surface that provides between about 0.5 g/m² and about 2 g/m² of additive on the polymer surface.

For such liquid formulations, the amount of additive in the coating composition upon application is between about 0.1% and about 10% by weight. For example, the formulated coating contains between about 0.2 to about 5% by weight additives, for example about 0.4 to about 2% by weight additives.

When incorporating additives via the instant method, the additives in the removable coating composition can be comprised of one compound or a mixture of compounds which together equal the percentage by weight detailed herein. The additives need not have the same activity, for example while a composition may contain two light stabilizers, or even two UVAs, it may also contain a light stabilizer and an anti-oxidant and/or an antistatic agent.

If the coating is applied as a gel, thick oil or waxy solid, the viscosity of the coating during application will be much higher, but the application methods, e.g., spreading the coating with a cloth or brush, may leave a much thinner initial layer. In this case the concentration of LS in the coating will generally be higher to attain the minimum of approximately 0.2 g/m² minimum of light stabilizer on the polymer surface.

In such a coating applied as a gel, oil or waxy solid, the additives comprises at least about 5 weight percent of the composition, based on the total weight of the composition and may even comprise substantially almost all of the composition. Preferably, the additive comprises between about 8 and about 50 weight percent of the composition. For example, for a coating composition of the present invention that is a gel, oil or waxy solid, additives comprise between about 10 and about 30 weight percent of the composition.

Regardless of composition form or method of application, neither of which is critical to practicing the invention, when incorporating additives via the instant method, the coating is formulated to leave at least 0.2 g/m² of additive, ideally between about 0.5 g/m² and about 2 g/m² deposited on the polymer surface throughout the time required for diffusion.

In light of the present disclosure, the exact formulations can be readily determined through routine experimentation by one of ordinary skill in the art.

The primary role of the carrier is to allow for the even application and intimate contact of additive with the polymer surface. Optionally, the carrier may also include a substantially non-volatile solvent capable of swelling the substrate one solvent being glycerin.

Useful carriers may be a single component or a mixture of materials chosen from the groups consisting of solvents, organic oligomers and polymers, rheology modifiers including thickeners, surfactants, soaps including soaps based on salts of fatty acids for example sodium lauryl sulfate, silicones and emulsifiers.

Examples of useful solvents include, but are not limited to water, hydrocarbon solvents for example octane, decane, dodecane, hexadecane, Stoddard solvent and Isopar solvents, fluorocarbons, aromatic solvents for example xylene and mesitilene, alcohols for example methanol, ethanol propanol, isopropanol, buutanol, iso butanol, t-butanol, hexanol, octanol, cylohexanol, decanol, fatty alcohols, glycols including ethylene glycol and propylene glycol, ketones for example acetone, butanone, pentanone, cyclopentanone and cyclohexanone, esters including acetate esters of aliphatic alcohols, amides, and ureas.

Organic oligomers and polymers include, but are not limited to petroleum jelly, parrafin oil, mineral oils, polyacrylic acid, acrylic oligomers, polyacrylates and polyacryllamides.

Thickeners and rheology modifiers include, but are not limited to pseudoplastic thixotropes, such as VISCALEX® AT89 (liquid dispersion acryllic acid copolymer) or VISCALEX® HV 30 (methacryllic acid copolymer associative thickener), Newtonian fluids, acrylic polymers, cross-linked acrylic polymers, associative thickeners, alginates, carrageenan, cellulose and derivatives (carboxymethylcellulose derivatives with different counterions such as sodium potassium, etc; hydroxypropyl cellulose, hydroxyethyl cellulose, hydroxypropylmethylcellulose, methylcellulose), guar, guar derivatives, locust bean gum, xanthan gum, organoclays, water-swellable clays, silica, polyvinylpyrrolidones, polyethylene, polyethylene oxide, alkali swellable emulsion thickeners (ASE), hydrophobically modified ASE's (HASE), hydrophobically modified urethane thickener (HEUR) and liquid dispersion polymers (LDPs).

Useful surfactants include, but are not limited to anionic surfactants, for example sulfonates, carboxylates, sulfates and phosphates; nonionic surfactants, for example acetylenic glycol, alkylpolyglycoside, alcohol ethoxylate, alkylphenol ethoxylate, alkanolamide, block copolymers, dialkylsiloxanes and fluorosurfactants; cationic surfactants, for example quarternary amines, and amphoterics, for example N-alkylbetaines.

The method of applying the coating of the composition is dependent in part on the composition characteristics, for example liquid or waxy solid, and is not critical to the invention. Application of the coating may be accomplished by spaying or spreading with an appropriate applicator, for example, a cloth, sponge, brush or other device used in the applications of a polish, oil, soap or wax.

One method of application is to spray the coating in liquid form onto the polymeric material to leave a coating, either as a wet film layer or a viscous liquid or emulsion, of the thickness described above.

In view of this disclosure, many modifications of this invention will be apparent to those skilled in the art. It is intended that all such modifications which fall within the true scope of the invention will be included within the terms of the appended claims.

### WORKING EXAMPLES

The following non-limiting examples help illustrate the invention.
UVA 1—2-(3′-tert-butyl-2′-hydroxy-5′-(2-octyloxycarbonylethyl)phenyl)benzotriazole,
UVA 2—the transesterification product of 2-[3′-tert-butyl-5′-(2-methoxycarbonylethyl)-2′-hydroxyphenyl]-2H-benzotriazole with polyethylene glycol 300,
UVA 3—2-[2′-hydroxy-3′-(α,α-dimethylbenzyl)-5′-(1,1,3,3-tetramethylbutyl)phenyl]benzotriazole,
UVA 4—the reaction product of tris(2,4-dihydroxyphenyl)-1,3,5-triazine with the mixture of α-chloropropionic esters (made from isomer mixture of C₇-C₉alcohols),
UVA 5 2-[4-(dodecyloxy/tridecyloxy-2-hydroxypropoxy)-2-hydroxyphenyl]-4,6-bis(2,4-dimethylphenyl)1,3,5-triazine,
UVA 6 2-(3′-dodecyl-5′-methyl-2′-hydroxyphenyl)-benzotriazole,
UVA 7 2,2′-dihydroxy-4-methoxybenzophenone
UVA 8 α-cyano-β,β-diphenylacrylic acid ethyl ester or isooctyl ester
HALS 1—bis(1-octyloxy-2,2,6,6-tetramethylpiperidin-4-yl)sebacate,
HALS 2—bis(1,2,2,6,6-pentamethylpiperidin-4-yl)sebacate,
HALS 3—7-Oxa-3,20-diazadispiro[5.1.11.2]heneicosane-20-propanoic acid, 2,2,4,4-tetramethyl-21-oxo-, dodecyl ester
HALS4—3-dodecyl-1-(2,2,6,6-tetramethyl-4-piperidinyl)-2,5-Pyrrolidinedione,
HALS 5—2,4-bis[N-Butyl-N-(1-cyclohexyloxy-2,2,6,6tetramethylpiperidin -4-yl)amino]-6-(2-hydroxyethylamine)-1,3,5-triazine
VISCALEX® AT89 is a liquid dispersion acryllic acid copolymer.
VISCALEX® HV 30 is a methacryllic acid copolymer associative thickener.
ISOPAR® H , TEXANOL® and Stoddard solvent are high boiling commercial hydrocarbon based solvents

The examples 1-14 illustrate compositions useful as removable coatings in the present invention. Other formulations are obvious to one skilled in the art in light of the present disclosure. All percentages are approximate weight percents of the total composition.

### Example 1

| | |
|---|---|
| High Viscosity Silicone | 15% |
| Low Viscosity Silicone | 10% |
| UVA 1 | 5% |
| HALS 1 | 5% |
| Emulsifier | 4% |
| VISCALEX ® AT89/ISOPAR ® H 1:1 | 2% |
| Water | 59% |

### Example2

| | |
|---|---|
| ISOPAR ® Solvent | 25% |
| UVA 8 | 5% |
| HALS 2 | 2.5% |
| sulfosuccinate wetting agent | 0.2% |
| aminomethylpropanol | 0.3% |
| VISCALEX ® HV 30 | 1% |
| Water | 66% |

### Example 3

| | |
|---|---|
| Paraffin Oil | 30% |
| UVA 4 | 3% |
| HALS 1 | 1.5% |
| WITCONATE ® P10-59 (wetting agent) | 1% |
| Triton X100 (biocide) | 1% |
| aminomethylpropanol | ˜0.3% |
| RHEOVIS ® 152 (reology modifyer) | 1% |
| Water | 62.2% |

### Example 4

| | |
|---|---|
| Montan wax | 50% |
| Aliphatic hydrocarbon solvent | 35% |
| HALS 1 | 5% |
| Hydrogenated Castor wax | 10% |

### Example 5

| | |
|---|---|
| Stoddard solvent | 20% |
| UVA 5 | 2% |
| Low MW Silicone | 10% |
| OPTIFLO ® H400 thickener (Sud-Chemie) | 5% |
| Morpholine oleate | 5% |
| Water | 58% |

### Example 6

| | |
|---|---|
| Texanol | 30% |
| UVA 2 | 5% |
| HALS 2 | 2% |
| VISCALEX ® HV 30 | 2% |
| aminomethylpropanol | ˜0.3% |
| Water | 60.7% |

### Example 7

| | |
|---|---|
| High Viscosity Silicone | 15% |
| Low Viscosity Silicone | 10% |
| UVA 1 | 1% |
| HALS 1 | 1% |
| Emulsifier | 4% |
| VISCALEX ® AT89/ISOPAR ® H 1:1 | 2% |
| Water | 67% |

### Example 8

| | |
|---|---|
| Isopar Solvent | 25% |
| UVA 7 | 1% |
| HALS 2 | 0.5% |
| Alcopol O | 0.2% |
| aminomethylpropanol | 0.3% |
| VISCALEX ® HV-30 | 1% |
| Water | 72% |

### Example 9

| | |
|---|---|
| Paraffin Oil | 30% |
| UVA 6 | 0.6% |
| HALS 5 | 1% |
| Witconate P1059 | 1% |
| Triton X100 | 1% |
| aminomethylpropanol | ˜0.3% |
| Rheovis 152 | 1% |
| Water | 65.1% |

### Example 10

| | |
|---|---|
| Montan wax | 50% |
| Aliphatic hydrocarbon solvent | 35% |
| HALS 3 | 1% |
| Hydrogenated Castor wax | 14% |

### Example 11

| | |
|---|---|
| Stoddard solvent | 20% |
| HALS 2 | 1% |
| Low MW Silicone | 10% |
| OPTIFLO ® H400 thickener (Sud-Chemie) | 5% |
| Morpholine oleate | 5% |
| Water | 59% |

### Example 12

| | |
|---|---|
| Texanol | 30% |
| UVA 2 | 1% |
| HALS 4 | 0.6% |
| VISCALEX ® HV 30 | 2% |
| aminomethylpropanol | ˜0.3% |
| Water | 66.1% |

### Example 13

| | |
|---|---|
| High Viscosity Silicone | 15% |
| Low Viscosity Silicone | 10% |
| UVA 1 | 0.5% |
| HALS 2 | 0.5% |
| Emulsifier | 4% |
| Emulsifier | 4% |
| VISCALEX ® AT89/ISOPAR ® H 1:1 | 2% |
| Water | 64% |

The viscosity of the above compositions is adjusted, if necessary, by standard means to between 1000 and 2000 cps when measured by a Brookfield Viscometer using a #4 spindle at 20 rpm. The coatings are applied to a light treated polymeric substrate by spraying onto the polymer surface, or alternately, the coatings are applied by passing an applicator, e. g., brush, sponge, cloth or paper wipe, saturated with one of the above compositions over the surface of the polymeric substrate.

### Example 14

The following formulation illustrates a much thicker coating which is to be applied at a thinner applied film build.

| | |
|---|---|
| Paraffin Oil | 40% |
| UVA 6 | 25% |
| HALS 1 | 10% |
| Witconate P1059 | 1% |
| Triton X100 | 1% |
| aminomethylpropanol | ˜0.3% |
| Rheovis 152 | 1% |
| Water | ˜12% |
| Hydrogenated Castor wax | ˜10% |

The formulation is homogenized and applied to a light treated polymeric substrate with a cloth to leave an even coat.

The Examples 15 and 16 show that previously UV exposed polymer films more readily absorb additive, than non-UV exposed polymer films.

### Example 15

Compositions of the present invention are applied to light treated substrates. The Light exposure of this example is longer than required but serves to illustrate the enhancement of additive absorption after light treatment and illustrates a method for determining additive incorporation. The UV absorption at 345 nm is used to determine the amount of UVA present using a Perkin Elmer Lambda 800 double beam spectrometer.

Quartz discs are spin coated with a model formulation of a commercial high solids thermoset acrylic melamine auto clear coat containing UVA 3, 1.5 weight % based on resin solids, and HALS 1, 1.0 weight % based on resin solids to yield after curing for 30 minutes at 250° F. films approximately 20 microns thick as measured by a Ziess Interferometer. The discs are exposed in an Atlas Ci65 Xenon Weatherometer under SAE J 1960 cycle with borosilicate inner and outer filters at 0.55 W/m² for 500 hours.

After 500 hour of light exposure, absorption spectra are obtained, samples are treated with one of the formulations below and stored in an oven at 55° C. for 24 hours, after which the samples are thoroughly washed, first with a water/dish detergent mixture then with an isopropanol/water mixture and UV absorption spectra are taken. One set of samples is left untreated for comparison.

Both stabilizer containing coating compositions of the present invention contain:
10 grams of a 60% aqueous emulsion of a non-ionic medium viscosity polydimethylsiloxane
90 grams of water
1.5 grams of a thickener
0.5 grams of aminomethylpropanol
1.2 grams of a glycol.
Formulation A also contains 1.2 grams of UVA 1.
Formulation B also contains 1.2 grams of UVA 1 and 1.2 grams of HALS 1.

The data appear in the table below.

| | Film | Absorption at 347 nm | | |
|---|---|---|---|---|
| Disc | Thickness | 0 hr | 500 hr light | 500 hr AT |

Untreated

| | | | | |
|---|---|---|---|---|
| 1-1 | 20.5 micron | 1.345 | 1.243 | — |
| 1-2 | 20.6 | 1.394 | 1.295 | — |
| 1-3 | 22.8 | 1.456 | 1.343 | — |

Treated with Formulation A

| | | | | |
|---|---|---|---|---|
| 2-1 | 22.5 micron | 1.368 | 1.254 | >4 |
| 2-2 | 21.4 | 1.427 | 1.319 | >4 |
| 2-3 | 22.8 | 1.466 | 1.375 | >4 |

Treated with Formulation B

| | | | | |
|---|---|---|---|---|
| 3-1 | 23.2 micron | 1.375 | 1.280 | 2.544 |
| 3-2 | 20.9 | 1.294 | 1.187 | 2.373 |
| 3-3 | 22.2 | 1.302 | 1.209 | 2.408 |

AT is the Absorption data taken after treatment with a composition of the present invention.

### Example 16

Formulation A from Example 15 is applied to non-weathered, unstabilized samples. The UV absorption at 345 nm is used to determine the amount of UVA present.

Quartz discs are spin coated with a model formulation of a commercial high solids thermoset acrylic melamine auto clear coat similar to that of Example 15 except that no light stabilizers are present, to yield after curing for 30 minutes at 250° F. films approximately 30 microns thick as measured by a Ziess Interferometer.

The samples are treated with Formulation A from Example 15. Samples are placed outside for 2, 4 and 8 hours (stand time) then thoroughly washed as above. A separate sample is stored in an oven at 55° C. for 24 hours then thoroughly washed as above. Absorption spectra are obtained before and after treatment.

Absorption at 347 nm

| Disc | stand time | BT | AT |
|---|---|---|---|
| 5 | 2 hr | 0.044 | 0.067 |
| 6 | 4 hr | 0.044 | 0.074 |
| 7 | 8 hr | 0.044 | 0.618 |
| 8 | 55° C. 24 hr | 0.045 | 0.222 |

BT is the Absorption data taken prior to treatment with a composition of the present invention.
AT is the Absorption data taken after treatment with a composition of the present invention.

While in each case UVA 1 is absorbed by the sample film, none of the samples of Experiment 16 have absorbed as much as the samples of discs 2-1, 2-2, 2-3 of Example 15.

### Example 17

A commercial biaxially orientated polypropylene packaging film and a formulated polypropylene cast film are passed once through a Fusion 600 watt VPS UV curing unit using H bulbs at 100% power and a speed of 14 feet/minute then treated with the Formulation A following the procedure of Example 16. The UV absorption at 345 nm is used to determine the amount of UVA present.

### Example 18

The process of Example 17 is repeated using a speed of 30 feet/minute.

### Example 19

The process of Example 18 is repeated but passing the films through the curing unit twice.

### Example 20

The process of Example 19 is repeated but passing the films through the curing unit four times.

### Example 21

The process of Example 18 is repeated but passing the films through the curing unit 8 times.

### Example 22

The process of Example 18 is repeated using but instead of polypropylene film, a polyester plaque and a polycarbonate plaque are used as substrates.

### Example 23

The process of Example 22 is repeated using but instead of polypropylene film, a TPO bumper is used as the substrate.

### Example 24

Compositions of the present invention are applied to light treated substrates. Quartz discs are spin coated with a model formulation of a UV-curable clearcoat formulation based on an aliphatic epoxy acrylate,/aliphatic urethane triacrylate/TPGDA (tripropylene glycol diacrylate)/TMPTA(trimethylol propane triacrylate) (48/32/8/12 weight %) containing 3% photoinitiator Irgacure 2959 (4(2-Hydroxyethyoxy)phenyl-2-hydroxy2-propyl ketone). The coating is spin-coat applied onto 1.5″ diameter quartz discs, to a film thickness of approximately 25 microns, and cured using two 80 W/cm H-type mercury bulbs in two passes at 10 m/min. Film thickness is determined using a Zeiss interferometer. Half of the discs are then subjected to two additional passes under the same UV-curing bulbs at 10 m/min.

The discs are either untreated, or treated with one of the formulations from example 16. Half of the discs treated with each formulation are stored in an oven for 1 hour at 60 deg C., w hile half are kept at room temperature for 24 hours.

The samples are washed, first with a water/dish detergent mixture then with an isopropanol/water mixture and UV absorption spectra are taken.

The untreated discs, both stored in the oven and at room temperature, show no UV absorbance spectra typical of a benzotriazole UV absorber.

The discs treated with Formulation A exhibit an absorbance spectrum typical of benzotriazole UVA 3. The absorbance of the oven-treated samples exhibit higher absorbance than those at room temperature.

The discs treated with Formulation B also exhibit an absorbance spectrum typical of benzotriazole UVA 3. The absorbance of the oven-treated samples exhibit higher absorbance than those at room temperature, and both samples exhibit somewhat lower absorbance than the samples treated with Formulation A.

We claim:

1. A method for incorporating additives into a polymeric substrate, which method comprises:
preparing a removable coating composition comprising an effective amount of an additive or additives formulated with a non-reactive carrier with sufficient viscosity or film forming properties to maintain a coherent layer on the polymeric substrate for a time sufficient to allow the additive or additives to diffuse into the substrate;
treating the surface of the polymeric substrate with light for a time sufficient to enhance diffusion into the substrate of the additive or additives of the removable coating composition;
after treatment with light applying the removable coating composition containing the additive or additives to the polymeric substrate; and
allowing the coating composition to remain in contact with the polymeric substrate for a sufficient time to allow the additive or additives to diffuse into the substrate.

2. A method according to claim 1 wherein at least one of the additives is selected from the group consisting of Ultra Violet absorbers and hindered amine light stabilizers.

3. A method according to claim 1 wherein additive or additives, in total, is present from about 0.1% to about 10% by weight, based on the weight of the total composition.

4. A method according to claim 1 wherein the coating composition is a liquid with a viscosity of between about 500 and about 10,000 cps when measured by a Brookfield Viscometer using a #4 spindle at 20 rpm.

5. A method according to claim 1 wherein the removable coating composition is a gel, oil or waxy solid which coating composition comprises between about 5% and about 50% weight percent additive or additives based on total weight of the composition.

6. A method according to claim 1 wherein the polymeric substrate is exposed to a dose of light of a minimum of about 1 joule/cm² prior to the application of the removable coating.

7. A method according to claim 6 wherein the dose of light is from about 3 to about 250 joule/cm².

8. A method according to claim 1 wherein the light used to treat the polymeric substrate prior to application of the removable coating comprises wavelengths between 190 and 450 nm.

9. A method according to claim 1 where the polymeric substrate is a cured coating over a metal, polymeric, wood, composite, ceramic or fiberglass substrate.

10. A method according to claim 9 where the coating is an automotive coating selected from the group consisting of acrylic/melamine, acrylic/urethane, polyester/urethane, epoxy/acid and silicone containing coatings.

11. A method according to claim 1 where the polymeric substrate is a thermoplastic article.

12. A method according to claim 12 where the thermoplastic article is comprised of a resin selected from the group consisting of polypropylene, polyethylene, thermoplastic polyolefins, PVC, styrenics, polyamides, aliphatic urethanes, aliphatic polyesters, aromatic polyesters, poylcarbonates, ionomers, unsaturated polyester resins, natural rubbers, synthetic rubbers and blends thereof.

13. A method according to claim 1 where the polymeric substrate is a thermoset or thermoplastic film.

14. A method according to claim 1 where the polymeric substrate is a composite material comprising a polymer and particles, nano-particles or fibers of wood, glass, clay or mineral material.

15. The method according to claim 2 wherein the ultraviolet light absorber is selected from the group consisting of benzotriazoles, ortho-hydroxybenzophenones, triphenyl triazines, benzylidene malonates, cyanoacrylates and oxanilides.

16. The method according to claim 2 wherein the ultraviolet light absorber is selected from the group consisting of
2-(3′-tert-butyl-2′-hydroxy-5′-(2-octyloxycarbonylethyl)phenyl)benzotriazole,
the transesterification product of 2-[3′-tert-butyl-5′-(2-methoxycarbonylethyl)-2′-hydroxyphenyl]-2H-benzotriazole with polyethylene glycol 300,
2-[2′-hydroxy-3′-(α,a-dimethylbenzyl)-5′-(1,1,3,3-tetramethylbutyl)phenyl]benzotriazole,
5-trifluoromethyl-2-(2-hydroxy-3-α-cumyl-5-tert-octylphenyl)-2H-benzotriazole,
the reaction product of tris(2,4-dihydroxyphenyl)-1,3,5-triazine with the mixture of α-chloropropionic esters (made from isomer mixture of C₇-C₉alcohols),
2-[4-(dodecyloxy/tridecyloxy-2-hydroxypropoxy)-2-hydroxyphenyl]-4,6-bis(2,4-dimethylphenyl)1 ,3,5-triazine,
2-(3′-dodecyl-5′-methyl-2′-hydroxyphenyl)-benzotriazole
2-(2′-hydroxy-5′-(2-hydroxyethyl)phenyl)benzotriazole,
2,2′-dihydroxy-4-methoxybenzophenone
2,2′,4,4′-tetrahydroxybenzophenone,
α-cyano-β,β-diphenylacrylic acid ethyl ester or isooctyl ester
di-(1,2,2,6,6-pentamethylpiperidin-4-yl) p-methoxybenzylidenemalonate, and
2-ethoxy-2′-ethyloxanilide,

17. The method according to claim 2 wherein the hindered amine light stabilizer is selected from the group consisting of
bis(1,2,2,6,6-pentamethylpiperidin-4-yl)sebacate,
bis(1-octyloxy-2,2,6,6-tetramethylpiperidin-4-yl)sebacate,
bis(2,2,6,6-tetramethylpiperidin-4-yl)sebacate,
7-Oxa-3,20-diazadispiro[5.1.11.2]heneicosane-20-propanoic acid, 2,2,4,4-tetramethyl-21-oxo-, dodecyl ester,
3-dodecyl-1-(2,2,6,6-tetramethyl-4-piperidinyl)-2,5-pyrrolidinedione,
1-acetyl-4-(3-dodecyl-2,5-dioxo-1-pyrrolidinyl)-2,2,6,6-tetramethyl-piperidine, and
2,4-bis[N-Butyl-N-(1-cyclohexyloxy-2,2,6,6 tetramethylpiperidin -4-yl)amino]-6-(2-hydroxyethylamine)-1,3,5-triazine.

18. The method according to claim 1 wherein the coating composition comprises one or more additives selected from the group consisting of antioxidants, dyes, optical brighteners, flow-control agents, antistatic agents, plasticizers, lubricants, slip agents, crosslinking agents, crosslinking boosters, halogen scavengers, smoke inhibitors, flameproofing agents, preservatives and biocides.

19. A method according to claim 1 wherein the polymeric substrate is held in an oven or heated area at temperatures between about 30° C. and about 70° C. for time period of about 0.5 to about 24 hours.
